(19) United States
(12) Patent Application Publication
(10) Pub. No.: US 2015/0082677 A1
(43) Pub. Date: Mar. 26, 2015

(54) METHOD OF MANUFACTURING FRAMES AND FRAME MAT BOARD DESIGN

(71) Applicant: Framed Memorabilia, LLC, Southlake, TX (US)

(72) Inventors: Dennis W. CRUMP, Southlake, TX (US); James S. KUHN, Southlake, TX (US)

(73) Assignee: Framed Memorabilia, LLC, Southlake, TX (US)

(21) Appl. No.: 14/035,568

(22) Filed: Sep. 24, 2013

(51) Int. Cl. A47G 1/06; B32B 38/00

(52) U.S. Cl. CPC A47G 1/0605; B32B 38/0004; A47G 1/0616; A47G 1/0627; B32B 2305/00
USPC 40/768; 156/250

(57) ABSTRACT

The invention is made by creating various designs by hand or via modern software for the purpose of manufacturing frames and frame mat board designs. These designs are then transferred, either from the virtual space where they were designed or by hand, to: vinyl, paper, canvas, metal, or other material for the purpose of designing the display face of a mat board, foam board, frame molding, glass or any other material that has the purpose of being the face of a frame. The finished product is a frame product that encompasses a design by utilizing original artwork, licensed artwork, patterns, designs, photographs, or common print patterns for the creation of a unique frame molding and mat board, or any other material or medium that could be used for the purpose of being the display face of a frame.

### CROSS-REFERENCE TO RELATED APPLICATIONS

None

### TECHNICAL FIELD

The present invention relates to a finished frame product comprising of a frame molding, glass, frame mat board and foam board, as well as the method of design that relates to the creation of the uniquely decorative finished frame product.

### BACKGROUND OF THE INVENTION

As consumers continue to display their various life accomplishments, posters, pictures, the demand for framing these documents in a unique way to complement the overall display has increased. For example, colleges and universities have already begun to provide diploma frames containing a mat board embossed with the school's logo. However, these prior art mats consist of a plain hued cardboard or paper-like mat which limits the design possibilities to a consumer to something such as an embossed logo. Additionally, the prior art frame molding used to border the entire product, typically consisted only of wood or plastic material. This also limits what can be displayed and designed on the frame molding.

The need to expand on these limited design options is increasing with the broad demographics that request a variety a frames and designs. For instance, a hunting enthusiast may choose to display a photograph of a prized hunt in a large frame consisting of a camouflage themed frame mat and or frame molding. In another instance, a college graduate may request a camouflage themed frame mat consisting of their school's colors. Therefore, the need to develop a method to create a custom decorative frame product that can be manufactured according to the specifications of a consumer, exists.

### SUMMARY OF THE INVENTION

It is therefore an object of the present invention to provide a distinctive article that can be created for a particular person, group, industry or event. Said invention also pursues to deliver an aesthetically pleasing creation when displayed by the end user. The present invention seeks to provide the ability to uniquely preserve proof of life activities and/or achievements as well. Furthermore, this method of manufacturing frames, facing frames and mat board designs provides a method of designing exclusive products that can be displayed in countless manners.

In accordance with the present invention, the creation of a unique mat and molding used for framing documents, artwork, pictures and/or photographs and the method of making these items is disclosed. In one embodiment of the present invention, a uniquely created image has been printed on a substrate (in this case casted vinyl) and affixed to the mat board directly. Where in the past this was not possible, this process allows the transformation of a plain mat board into part of the overall design and aesthetics while simultaneously still “matting and framing” the significant document. In this embodiment the design has been created to uniquely display a high school, or secondary education diploma. In addition to the mat board that has been incorporated into the creative design using the above method, custom names, logos, seals, organizational names or other needed particulars can be added to the unique design of the mat board.

Encompassed in another embodiment, the molding of the frame has been altered. While plain wood or plastic was the only option for creating frames in the past, the creation of a one of a kind decorative molding is now able to be fashioned. This is achieved by using a uniquely created image and printing it on a substrate, (in this case casted vinyl) and affixing it to the molding directly. In this particular embodiment, the design has been created to uniquely display artwork, image, picture or photograph for decorative purposes.

### BRIEF DESCRIPTION OF THE DRAWINGS

FIG. 1: Molding being sized to specification by mechanical device according to the present invention.

FIG. 2: Correctly sized molding sections being joined using mechanical v-nailer according to the present invention.

FIG. 3: Designed substrate being applied to molding according to the present invention.

FIG. 4: Completed molding with designed substrate according to the present invention.

FIG. 5: Protective glass being sized to fit the finished product with mechanical device according to the present invention.

FIG. 6: Foam board being sized to fit the finished product with mechanical device according to the present invention.

FIG. 7: Computer image of a newly designed print prior to the manufacturing process according to the present invention.

FIG. 8: Computer image of a newly designed licensed collegiate name and logo prior to manufacturing process according to the present invention.

FIG. 9: Computer image of a projected final product with licensed collegiate name and logo prior to the manufacturing process according to the present invention.

FIG. 10: Substrate after image has been transferred before application in according to the present invention.

FIG. 11: Designed and printed substrate being adhered to a mat according to the present invention.

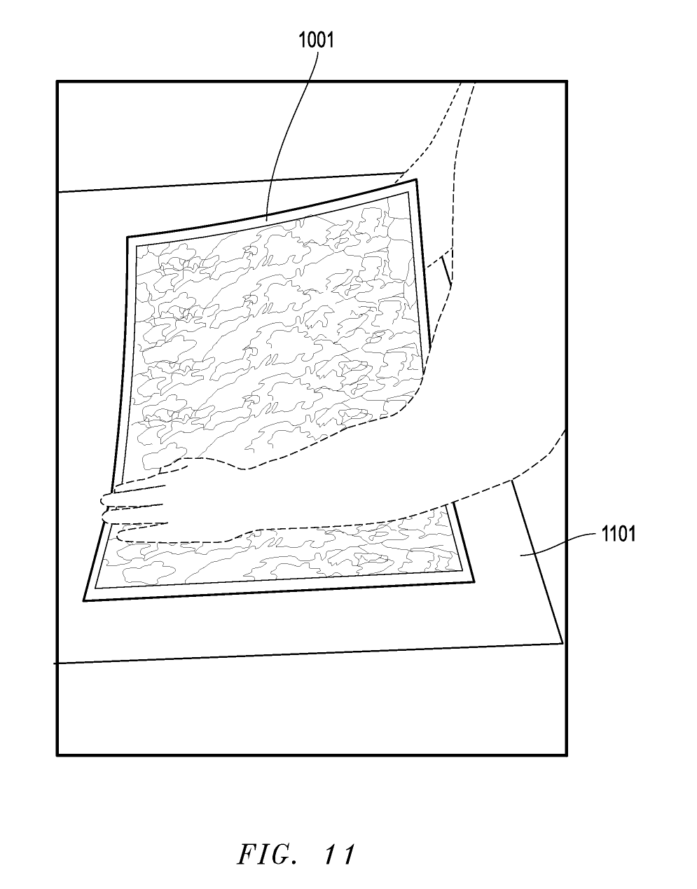

FIG. 12: Designed and printed substrate being adhered to a mat according to the present invention.

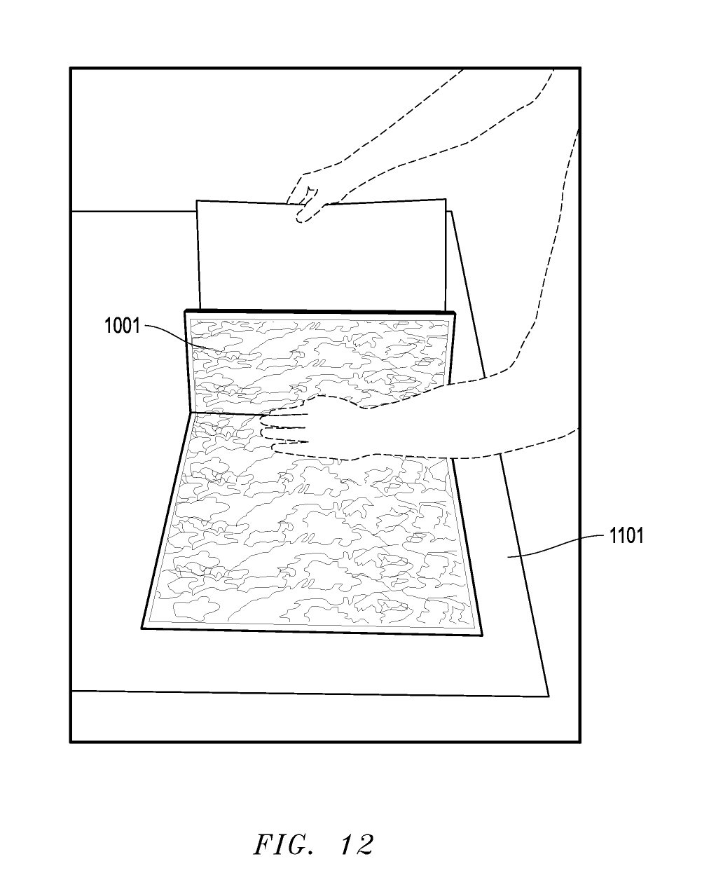

FIG. 13: Designed and printed substrate being adhered to a mat according to the present invention.

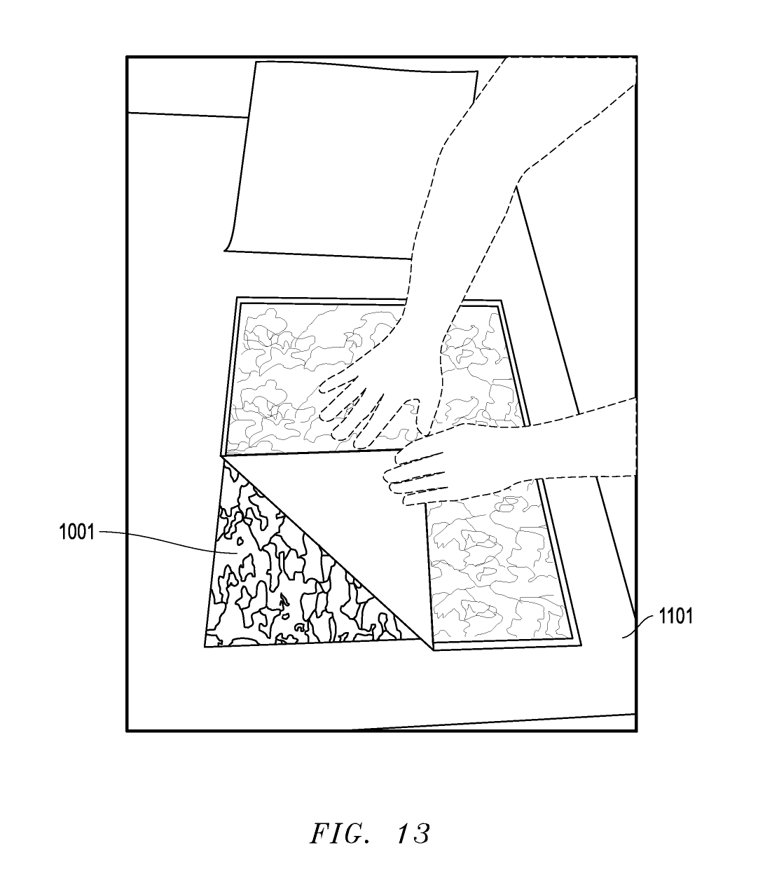

FIG. 14: Mat board with image prior to being sized with computerized mat cutter according to the present invention.

FIG. 15: Mat board with image being sized to fit the finished product with computerized mat cutter according to the present invention.

FIG. 16: Mat board with image being sized to fit the finished product with computerized mat cutter according to the present invention.

FIG. 17: Mat board with image post being sized to fit the finished product with computerized mat cutter with excess material according to the present invention.

FIG. 18: Mat board with image post being sized to fit the finished product with computerized mat cutter according to the present invention.

FIG. 19: Finished mat being inserted into back of frame according to the present invention

FIG. 20: Front view of the assembled final product with decorative mat and licensed collegiate name and logo according to the present invention.

FIG. 21: Front view of assembled molding with mat with accessories attached according to the present invention.

FIG. 22: Angled view of assembled molding with mat with accessories attached according to the present invention.

FIG. 23: Front view of assembled molding with mat with accessories attached according to the present invention.

### DESCRIPTION OF THE PREFERRED EMBODIMENT

### Molding

The shape, size, thickness and color of the face and core of the molding are not limited. For the purpose of the present invention, a molding is defined as a strip of wood or plastic or any other structural material that is used to decorate or create a frame around a document, picture, art or photograph. Below are the stages in building a molding according to the present invention:

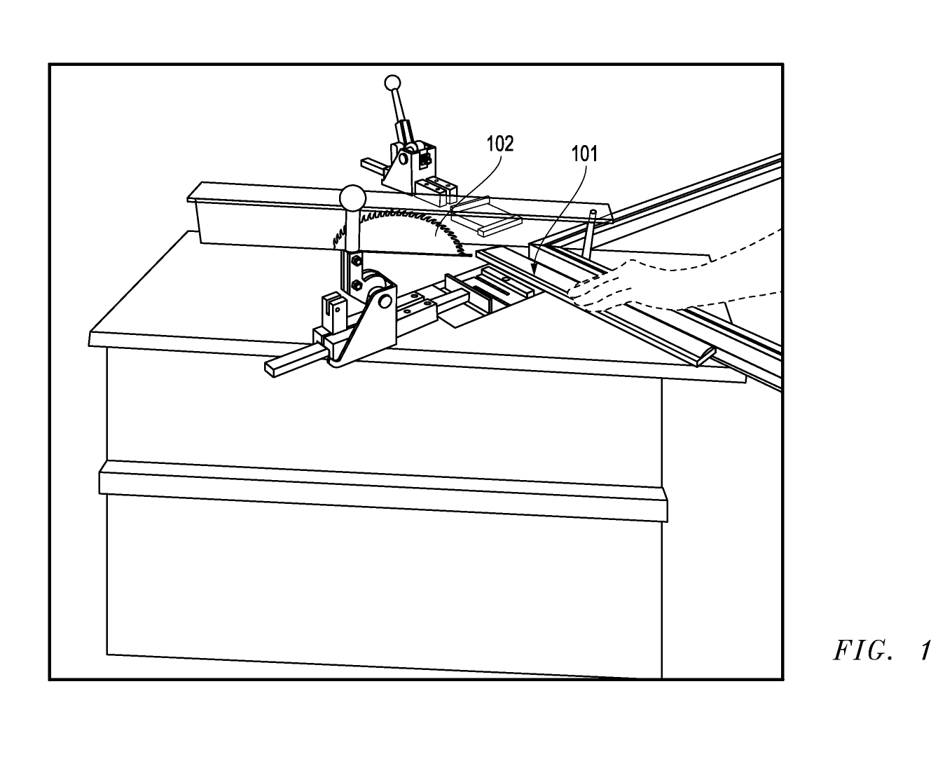

1) By hand with a cutting a tool or with a mechanical saw, the molding is cut into sections in the correct size to be used to assemble the frame. The molding pieces 101 can be precut and/or joined by an outside source. FIG. 1 shows the molding piece 101 being sized to specification by mechanical device 102 according to the present invention.

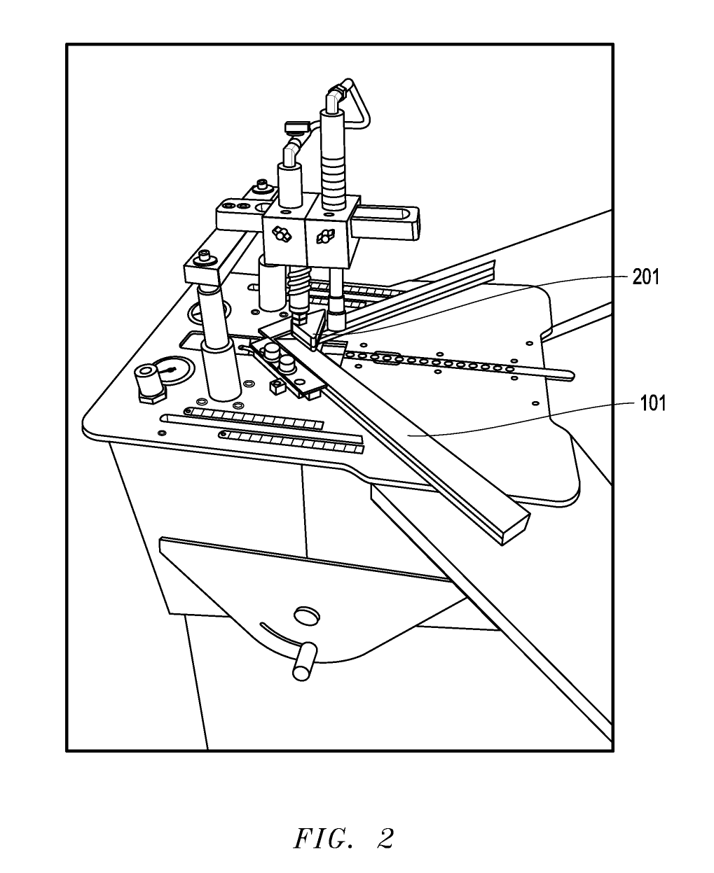

2) Using V-nails, glue, adhesives, and/or any other method, the cut pieces of molding are joined to create the final shape of the frame. This process can be done by hand, v-nailing mechanical equipment or tools, or any other materials used to apply adhesives. FIG. 2 shows a correctly sized molding piece 101 being joined using a mechanical v-nailer 201 according to the present invention.

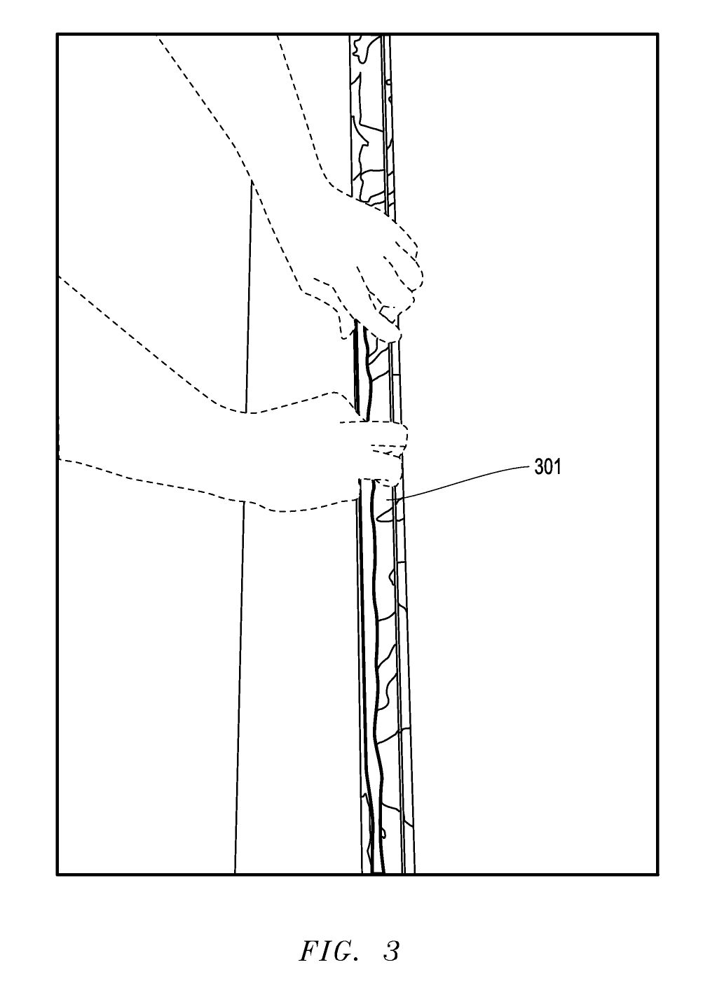

One version of this embodiment calls for the frame itself to have decorative molding. When called for, decorative molding will be fabricated. Using various designs created by hand or via modern software, these designs are then applied to vinyl, paper, canvas, or fabric. Once a media is established, it is then adhered to the sections of cut molding. FIG. 3 illustrates the designed substrate 301 being applied to molding according to the present invention.

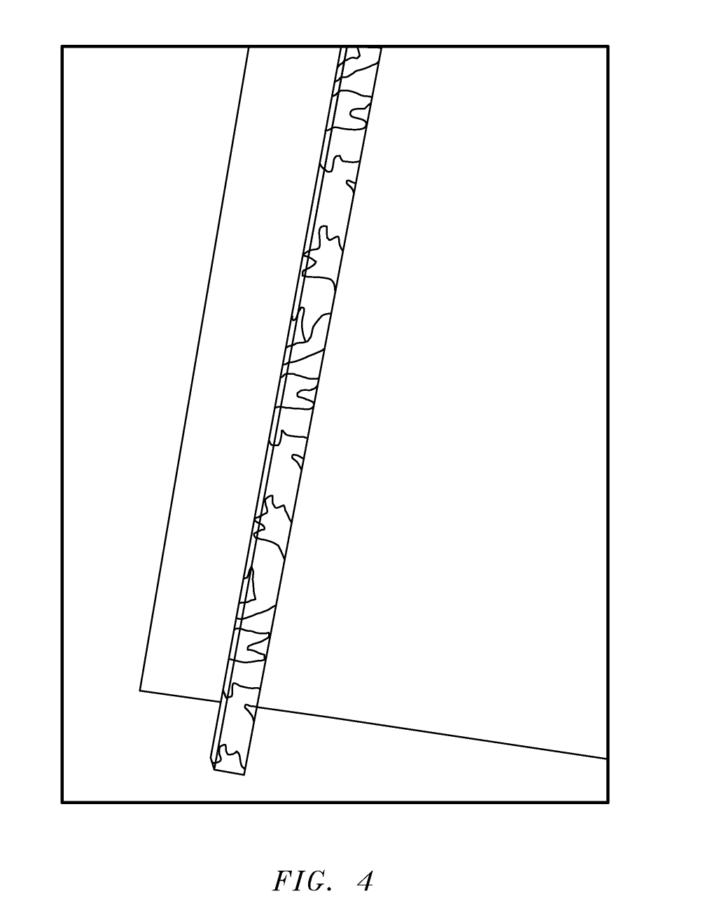

3) Adhering is done using glue, adhesives, staples and/or any other material that could be used to affix the substrate to the molding. The altered molding is then put together as described above in step 2. It must be noted that the decorative molding can be created after the frame has been created using the naked molding. FIG. 4 shows the completed molding with designed substrate according to the present invention.

### Glass

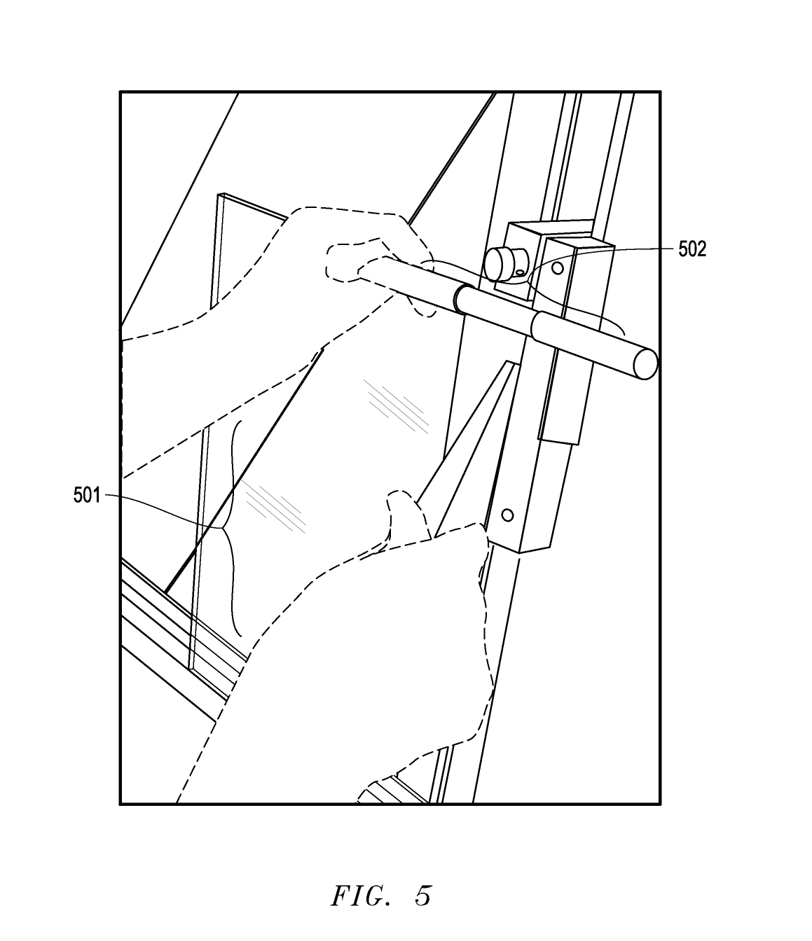

The shape, size, thickness and color of the face and core of the glass are not limited. Glass is not required to be utilized for the creation of this invention. When applicable, glass is cut to the correct size. This is typically the same size of the mat board and/or foam board it coincides with. Glass can be precut by an outside source or by hand or tools or equipment used to cut glass. Referring to FIG. 5, the protective glass 501 is sized to fit the finished product with mechanical device 502 according to the present invention. Different types of material can be used to aid in the functionality that glass contributes. Types of material include: Plexiglas, acrylics, UV-protective glass, non-glare glass, tinted glass or any other clear material that can be used in the frame to protect the document, picture, or photograph that is being framed. When called for, decorative glass may be fabricated. Using various designs created by hand or via modern software, these designs are then applied to the glass using vinyl, paper, canvas, fabric, paint or actual etching of the glass surface. Once a media is established, decorative glass will be fabricated.

### Foam Board

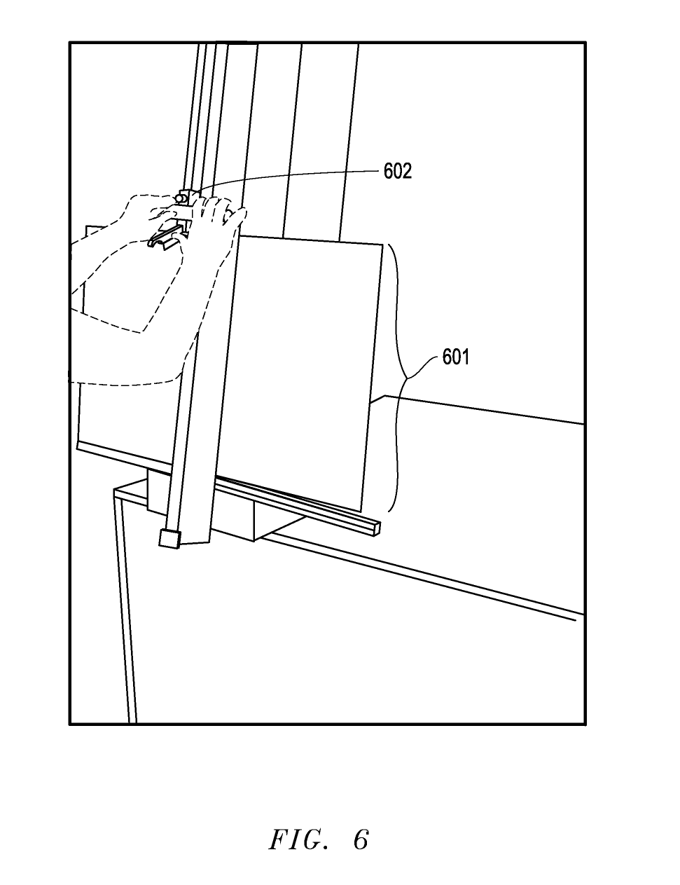

The shape, size, thickness and color of the face and core of the foam board are not limited. Foam board, commonly known as ‘foamcore’, is typically a strong, lightweight and easily cut material used as backing and mounting during the framing process. Foam board typically consists of three layers: an inner layer of foam-like material, and two outer-facing layers that are normally smooth in texture. Foam board is cut by hand or by using tools or mechanical equipment to the correct size needed to fit the back of the frame. Referring to FIG. 6, the foam board 601 is sized to fit the finished frame product by using a mechanical device 602 according to the present invention. The foam board will typically be cut to the same dimensions as the mat board. The foam board can also be cut by an outside source.

### Mat Board (Herein Referred to as Mat)

The shape, size, thickness and color of the face and core of the mat board are not limited. In the framing industry a mat is normally a thin, flat piece of paper based material which serves as many functions such as decoration and from separating the document, artwork, picture or photograph from the glass. Mats can also be used in conjunction with a fillet or wooden liners or cloth materials and additional mats. The present invention typically includes the following steps for producing a distinctive decorative mat or face of a frame being displayed for the finished product. Designs change from application to application but what remains true is the unique system in which the decorative mat is produced. (Supporting details provided below.)

1) Image Design.

2) Transfer of Designed Image to a Substrate.

3) Adhering designed substrate to the mat/foam board/molding/face of the frame.

4) Substrate with image is sized to fit the finished product and includes an opening/openings to appropriate document(s), artwork(s), picture(s) or photograph(s).

### Detailed Step 1: Image Design

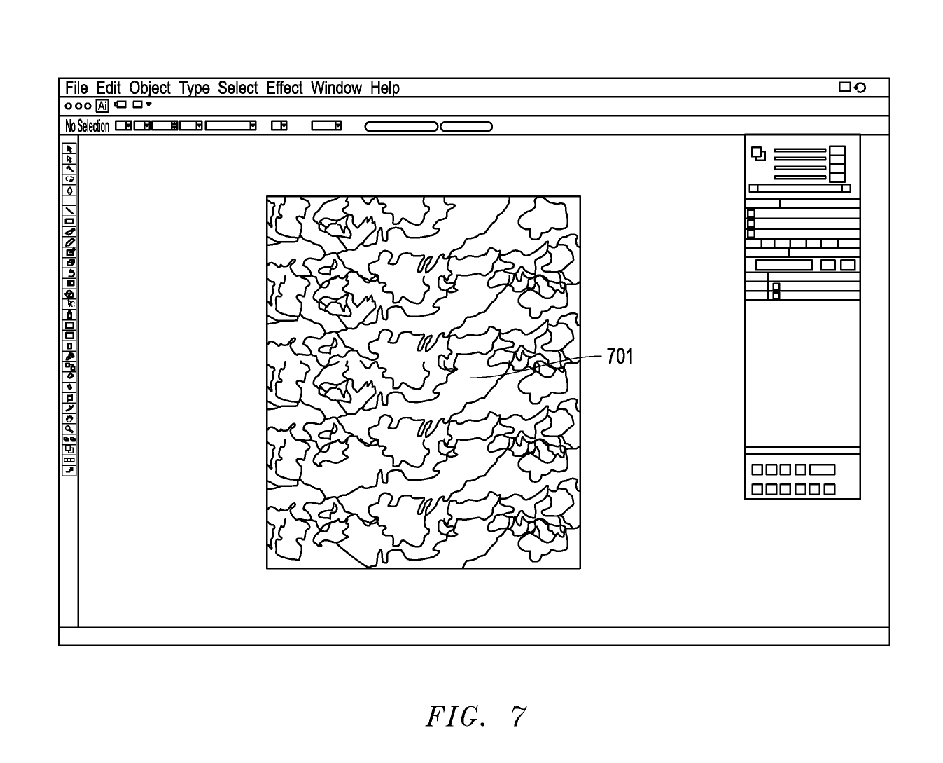

For the present invention, the image to be designed is for the purpose of appealing to the targeted individual, group or industry. This will include, but not limited to, custom designed pieces and licensed patterns and designs. The majority of designs will be created for reproduction. This is obtained most effectively by using computer software such as, but not limited to, Adobe Illustrator, Photoshop or InDesign to create easily manipulated samples. FIG. 7 shows the computer image 701 of a newly designed print prior to the manufacturing process according to the present invention. The computer image 701 shows a design illustration created in Adobe Illustrator for the purpose of manufacturing. Furthermore, it will not be uncommon for custom, one of a kind designs to be created that will not require duplication. For the present invention, these custom pieces could be designed by computer software or by other means of creating artwork such as hand illustration (or oil paints, watercolor, charcoals, pen and ink, colored pencils, etc.).

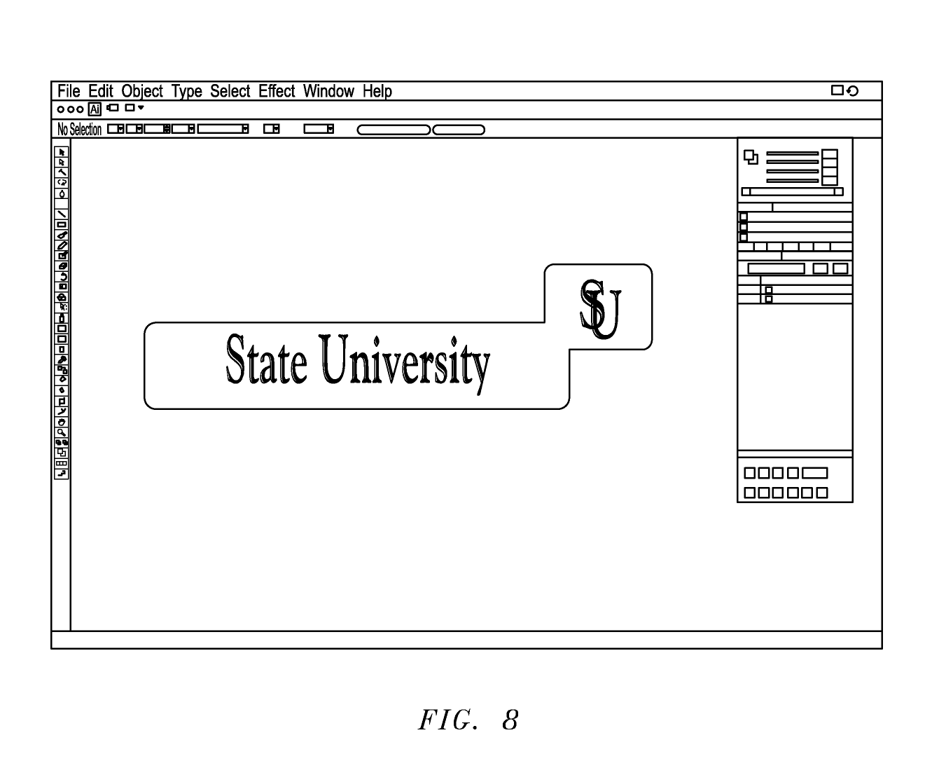

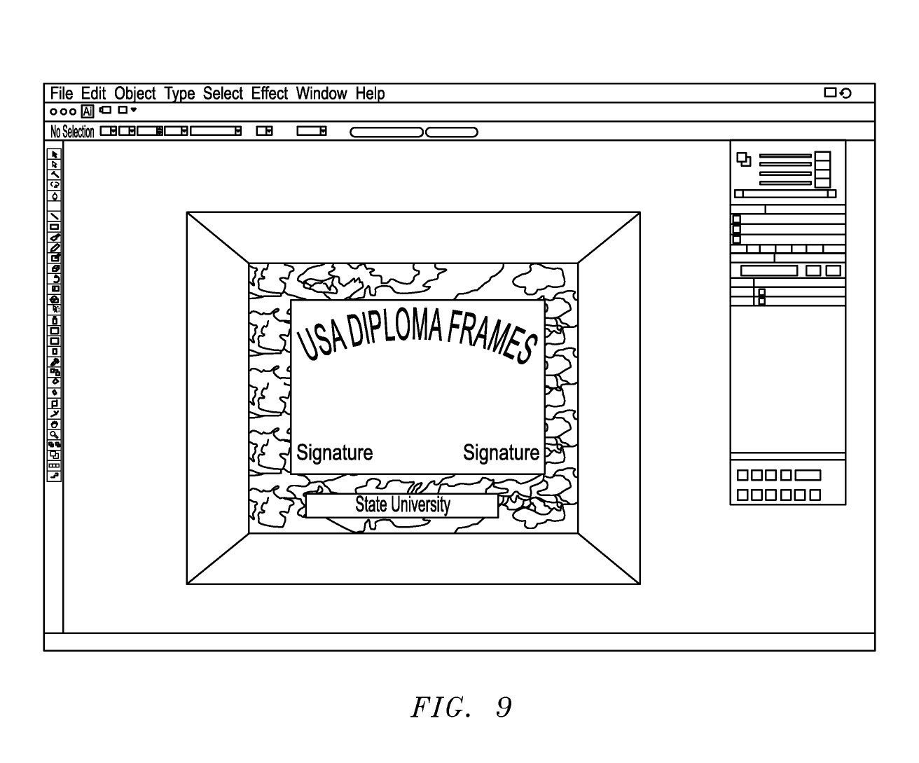

FIGS. 8 and 9 show additional computer images that prior to the manufacturing process that are contemplated by the present invention.

### Detailed Step 2: Transfer of Designed Image to a Substrate

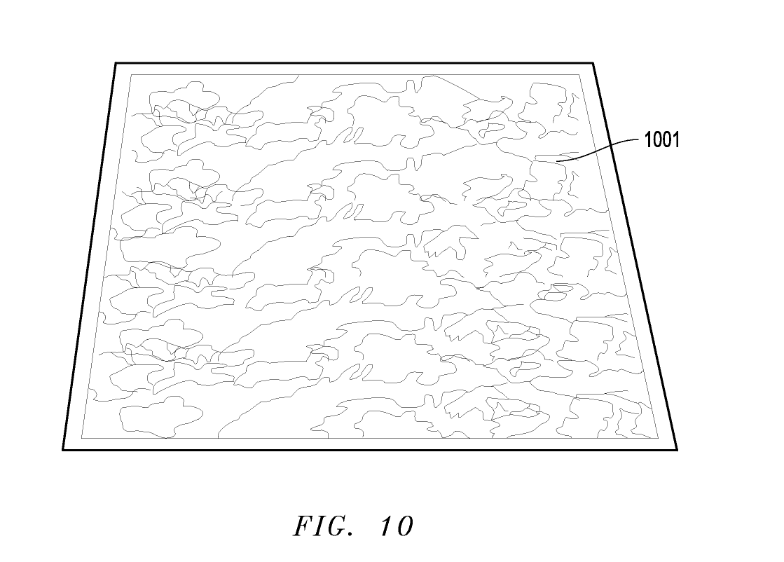

Once an image has been created and designed by whatever means necessary, the image must be transferred to the mat/foam board/molding/face of the frame. This can be accomplished by printing directly to the mat/foam board/molding/face of the frame; or using various methods and substrates such as vinyl, paper, canvas material, plastic, metal or other material depending on design needs. The transfer can occur by many different methods such as high-resolution printing, lithography, silk screening and other means of creating artwork such as hand illustration (or oil paints, watercolor, charcoals, pen and ink, colored pencils, etc.). Referring to FIG. 10, a vinyl substrate is shown after an image 1001 has been transferred onto the substrate, but before application to the mat/foam board or frame molding according to the present invention.

### Detailed Step 3: Adhering Designed Substrate to The Mat/Foam Board/Molding/Face of the Frame

FIGS.. 11, 12, and 13 depict the designed image 1001 that was printed on vinyl substrate being adhered to a mat 1101. After the image 1001 has been transferred to a substrate, it is adhered to a mat/foam board/molding/face of the frame. This can be accomplished using an adhesive. Adhesive can be defined as anything being coated with glue, paste, mastic or any other sticky substance for the purpose joining to substrates or holding it in place. Other forms of adhering a designed substrate can be used such as tape, staples, tacks, metal or plastic fasteners, or any other method of holding the substrate in place. For the purpose of this invention, the designed and printed substrate is adhered to a mat/foam board/molding/face of a frame. The only reason an adhesive or other form of adhering would not be called for is if printing directly to the mat/foam board/molding/face of the frame was the chosen design method.

Detailed Step 4: Substrate or Mat Board with Image is Sized to Fit the Finished Product and Includes an Opening/Openings To Appropriate Document(s), Artwork(s), Picture(s) Or Photograph(s)

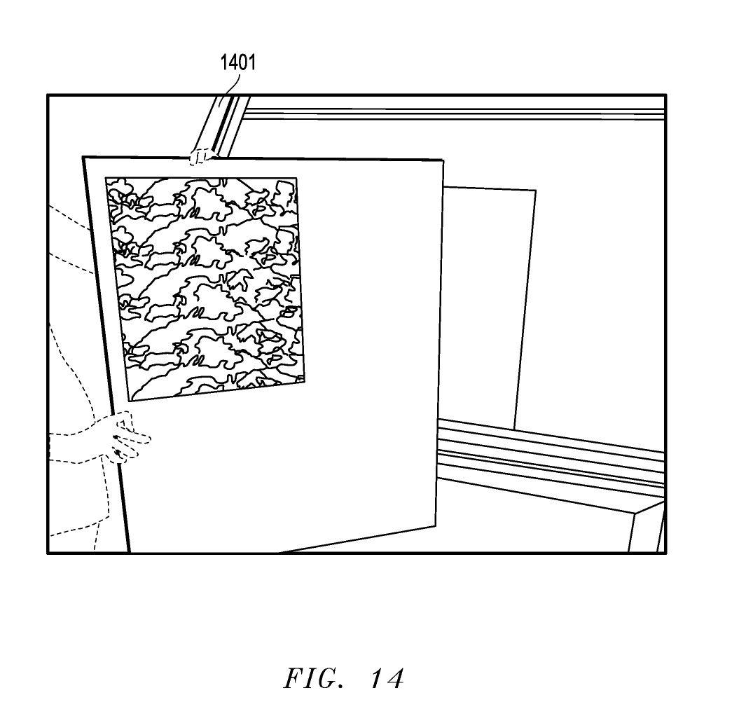

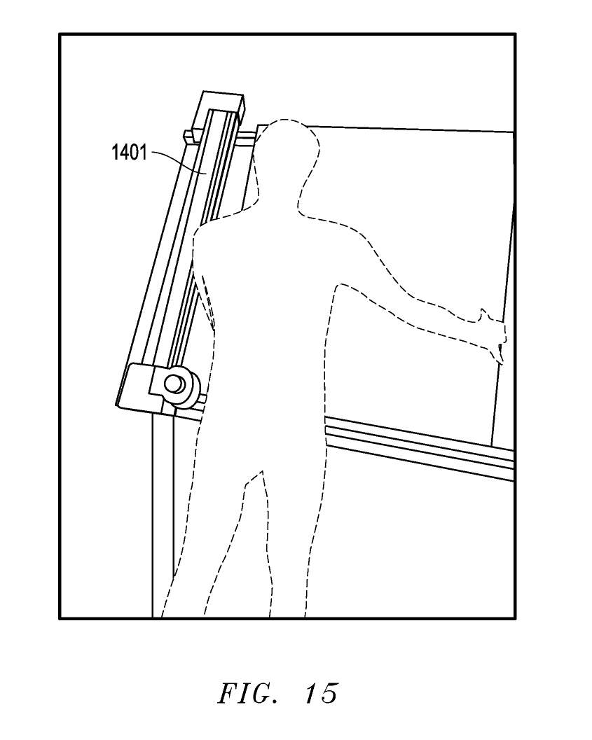

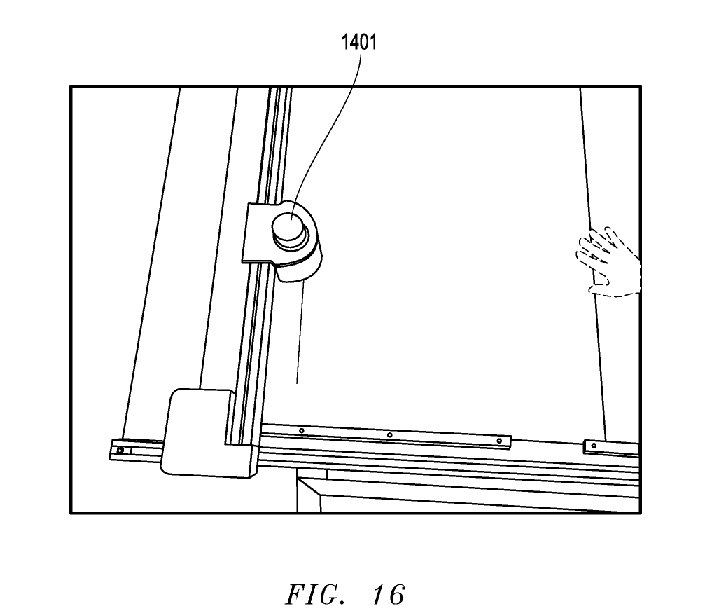

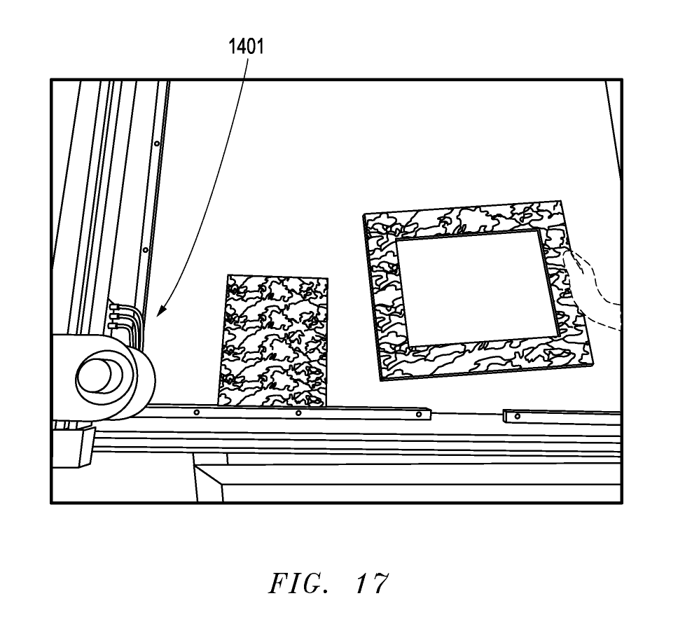

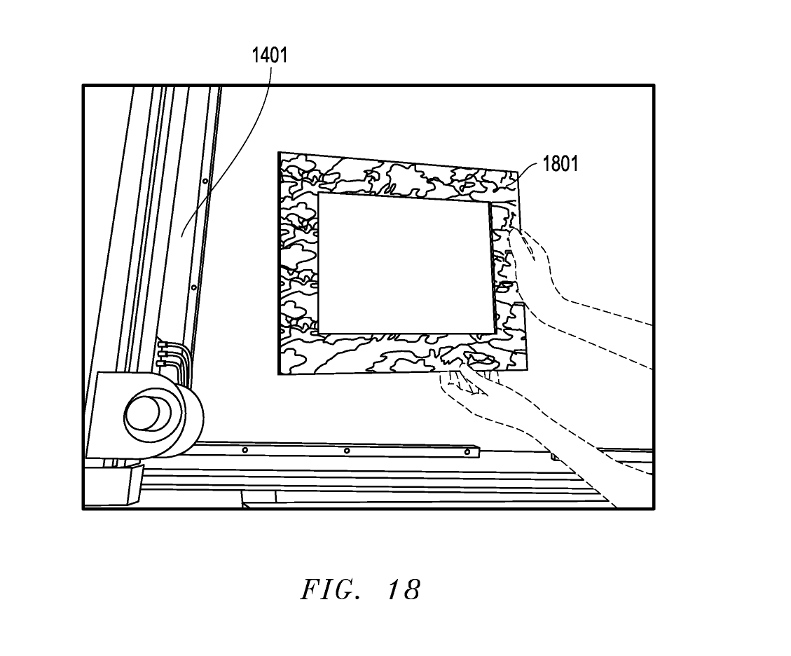

FIGS. 14, 15, 16, 17, & 18 depict a mat board with image being sized to fit the finished product with computerized mat cutter 1401. Referring specifically to FIG. 18, the computerized mat cutter 1401 cuts the original mat board with image into the finished mat 1801. This can also be accomplished by cutting the substrate by hand or any other tool or equipment that will size the substrate to the finished product specifications. Tools can include an exacto-knife, razor blade, cutting wheel, mechanical cutter or trim cutter.

### Building the Frame

The following is the process of putting all the variables together correctly to create the final product in accordance with the invention:

1) Lay the frame molding face down onto a flat surface and insert finished glass (if applicable) into the back of the frame.

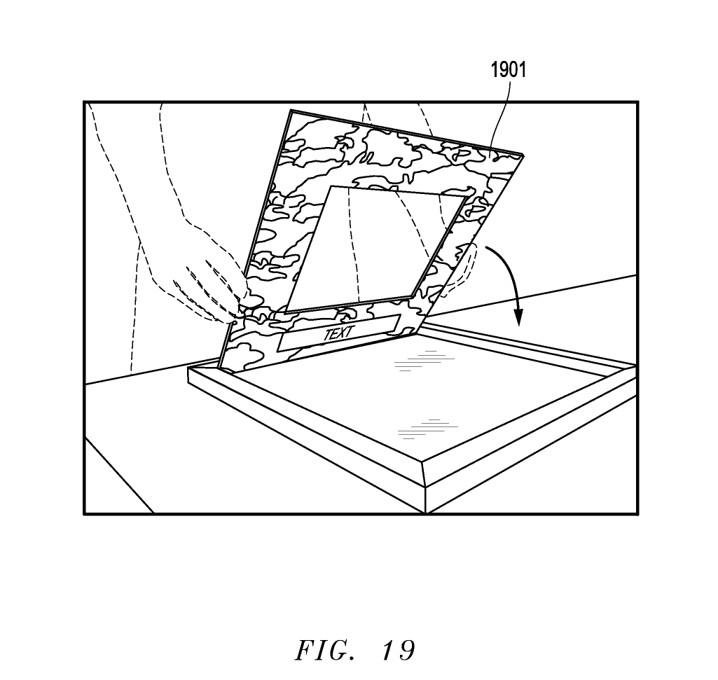

2) Place the finished mat board face down on top of the glass into the back of the frame. FIG. 19 shows the finished mat 1801 being inserted into back of frame according to the present invention.

3) Typically at this time, the document, artwork, picture or photograph is mounted to the back of the mat board or to the face of the foam board. This can be accomplished by using adhesives, tape, glues or other mounting techniques such as ‘dry mounting’. This process can be done before the materials have been assembled to create the frame. It will not be uncommon in some circumstances for document, artwork, picture, or photograph to be mounted by the end user.

4) Place the readied foam board face down on top of the mat board in the back of the frame that may or may not have document, artwork, picture or photograph adhered to it.

5) Using a staple gun or under-pinner (or by hand), insert framers points or staples to secure the materials into the back of the frame.

6) If applicable, add a paper backing to conceal the back of the frame.

7) Attach hanging materials (various types are available) or easel backs to the back of the frame to allow end user full displaying options.

8) Apply rubber or acrylic bumper pads to the back of the frame to prevent damage to the surface it is being displayed on.

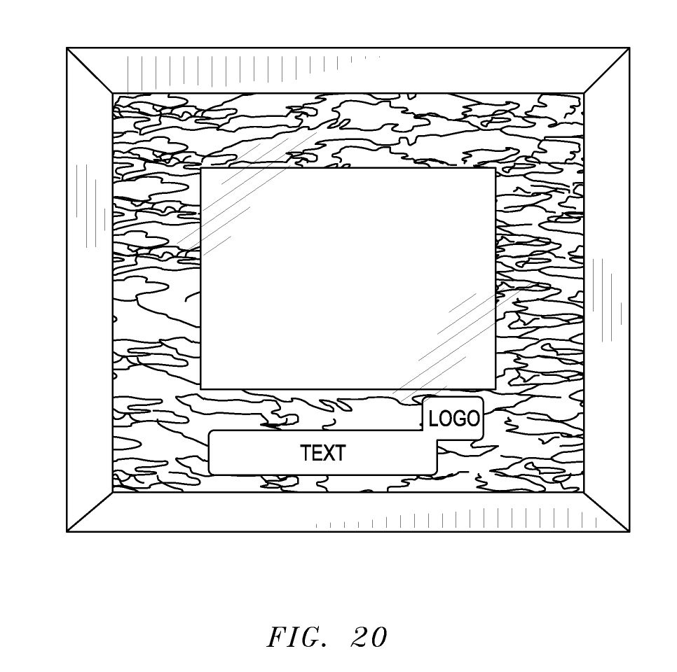

FIG. 20 shows a front view of the assembled final product with decorative mat and licensed collegiate name and logo according to the present invention.

### Accessories

Any accessory that allows for functionality and aesthetics are not limited. Additional accessories can be applied to the front (face) and/or sides to add uniqueness and functionality. This can include, but not limited to, hooks, wires, bottle openers, school logos/mascots/seals, shot glass holders, koozie-holders, hat hook, picture clips etc. Certain accessories that are added will be a catalyst for re-purposing the frame. For example, the bottle opener would change the function of the frame completely. Other items that could be displayed for re-purposing: duck call lanyards, event ticket lanyards, inserted shot glass holders, fraternity paddle, hats, koozies, cups, beads, bottle opener, photo-holders, photos hanging from wire attachments, cowboy hats, deer antlers, pledge pins, cork board, stuffed animals or other fraternity or sorority items.

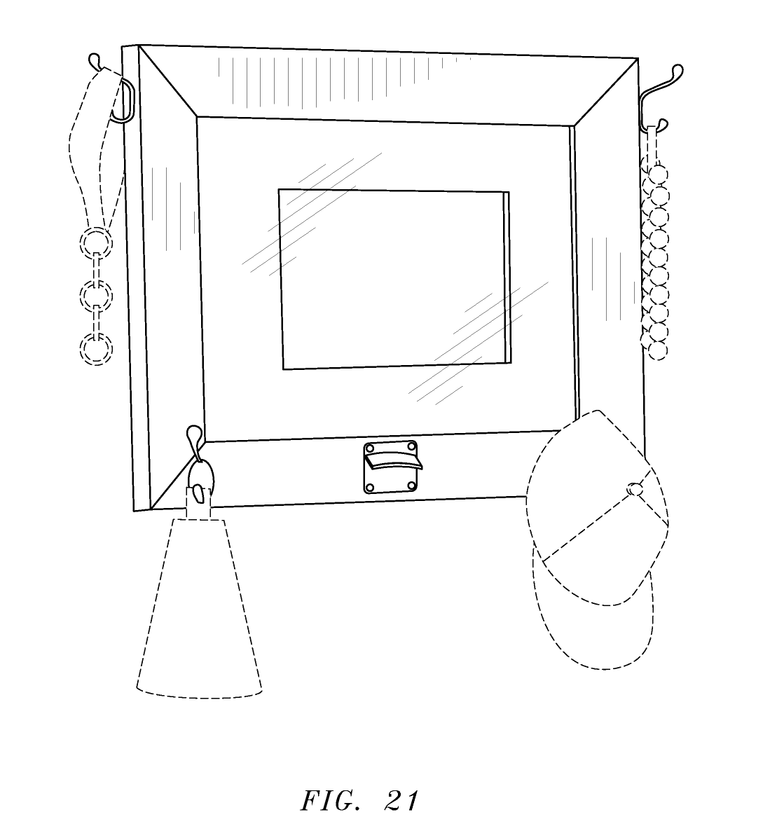

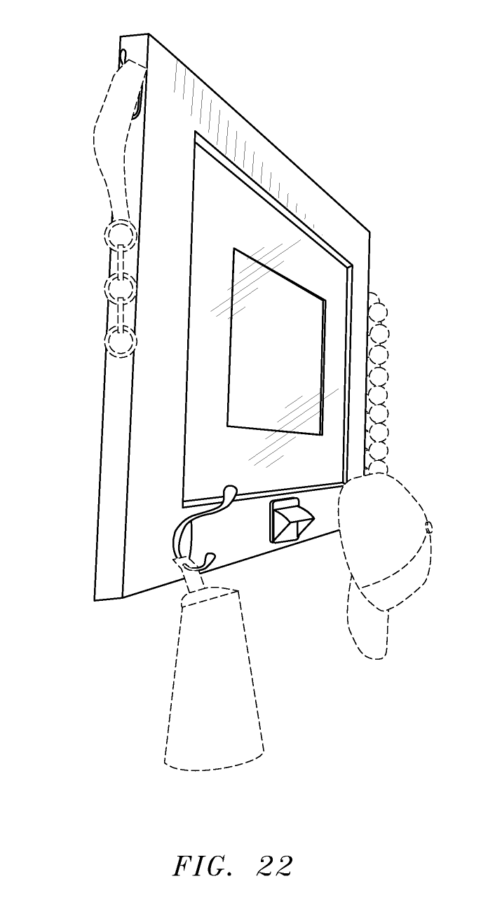

FIGS. 21 and 22 are two different views of an assembled frame product with accessories attached according to the present invention.

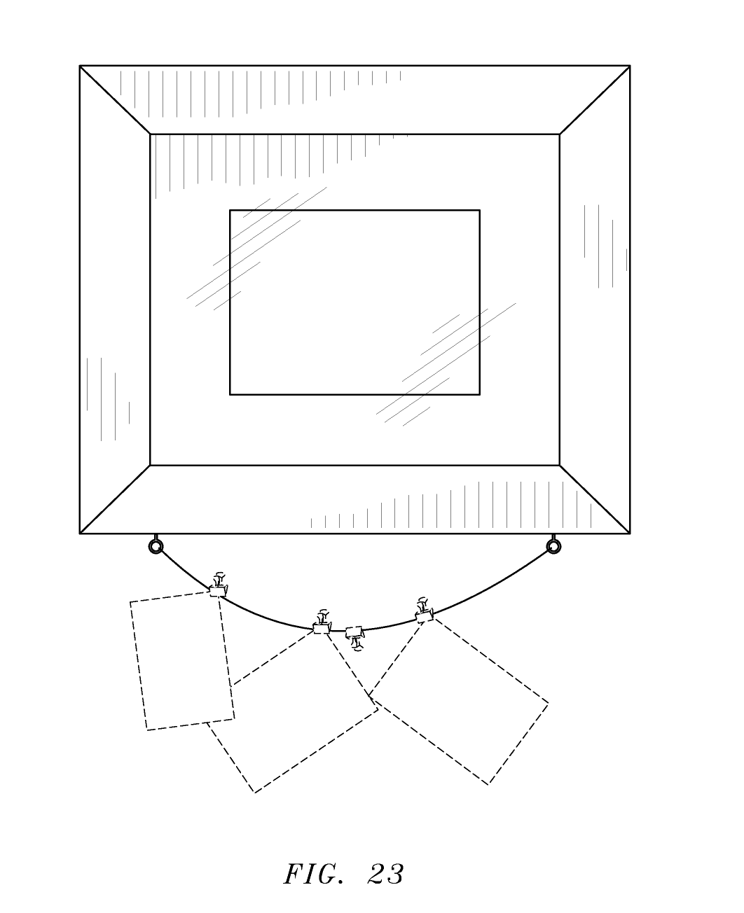

FIG. 23 shows a front view of assembled molding with mat with a different variation of accessories attached according to the present invention.

Having now fully described the invention, it will be apparent to one of ordinary skill in the art that many changes and modifications can be made thereto without departing from the spirit or scope of the invention as set forth herein.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the field or any related fields are intended to be within the scope of the following claims.

What is claimed is:

1. A method of manufacturing a finished frame product having a frame molding, mat board, or foam board utilizing design patterns, wherein said method comprises the steps of:
a. creating a distinctively decorative design consisting of licensed logos, artwork, or other design patterns;
b. transferring the design onto a substrate material;
c. adhering the designed substrate material to the mat board, foam board, or frame molding; and
d. sizing the designed mat board, foam board, or frame molding in accordance with the desired product specifications.

2. The method defined in claim 1 wherein the design may be directly applied to a mat board, foam board, or frame molding.

3. The method defined in claim 1 wherein the decorative design may be created using computer software.

4. The method defined in claim 1 wherein the decorative design may be created using hand illustration.

5. The method defined in claim 1 wherein transferring the design may be accomplished by high-resolution printing.

6. The method defined in claim 1 wherein transferring the design may be accomplished by lithography.

7. The method defined in claim 1 wherein transferring the design may be accomplished by silk screening.

8. The method defined in claim 1 wherein transferring the design may be accomplished by hand illustration.

9. The method defined in claim 1 wherein the substrate may be adhered with glue or other such sticky substance.

10. The method defined in claim 1 wherein the substrate may be adhered with staples or any other fasteners.

11. The method defined in claim 1 wherein the mat board or foam board is sized with a computerized mat cutter.

12. The method defined in claim 1 wherein the mat board or foam board is sized with an exacto-knife or other hand tool used to measure and cut.

13. A finished frame product manufactured by the process of claim 1.

14. A finished frame product comprising:
a. a molding frame used to decorate or create a frame around the document or item to be displayed;
b. a protective glass layer configured to cover and be the same size of the mat board or foam board;
c. a mat board configured to provide a decorative separation layer between the document to be displayed and the protective glass layer;
d. a foam board configured to provide a backing for the finished frame product.

15. The finished frame product as claimed in claim 14 wherein the molding frame is further comprised of a strip of wood or any other structural material.

16. The finished frame product as claimed in claim 14 wherein the protective glass is further comprised of any clear material.

17. The finished frame product as claimed in claim 14 wherein the mat board is further comprised of a flat piece of paper based material that may be used in conjunction with cloth, wooden liners, or other substrate materials.

18. The finished frame product as claimed in claim 14 wherein the foam board is further comprised of layers of light-weight material.

19. The finished frame product as claimed in claim 14 further comprised of accessories that add functionality or aesthetics.

20. A finished frame product having a frame molding, mat board, or foam board utilizing design patterns, prepared by a process comprising the steps of:
a. creating a distinctively decorative design consisting of licensed logos, artwork, or other design patterns;
b. applying the design either directly onto a mat board, foam board, or frame molding, or transferring the design onto a substrate material;
c. adhering the designed substrate to the mat board, foam board, or frame molding; and
d. sizing the designed mat board foam board, or frame molding in accordance with the desired product specifications.
